(19) United States
(12) Patent Application Publication
(10) Pub. No.: US 2025/0205820 A1
(43) Pub. Date: Jun. 26, 2025

(54) LASER WELDING METHOD FOR MULTI-LAYER ALUMINUM FOIL, BATTERY, WELDING SYSTEM, AND CONTROL DEVICE

(71) Applicant: TRUMPF (China) Co., Ltd., Jiangsu (CN)

(72) Inventors: Yuan Liu, Jiangsu (CN); Weiyu Wang, Jiangsu (CN); Chunyang Zhou, Jiangsu (CN); Franz Lehleuter, Jiangsu (CN)

(21) Appl. No.: 19/078,439

(22) Filed: Mar. 13, 2025

Related U.S. Application Data
(63) Continuation of application No. PCT/CN2023/119016, filed on Sep. 15, 2023.

(30) Foreign Application Priority Data
Sep. 16, 2022 (CN) 202211129537.9

(51) Int. Cl. B23K 26/22; B23K 26/06; B23K 26/064; B23K 26/24; B23K 26/60; B23K 26/70; B23K 101/38; B23K 103/10; B23K 103/16; H01M 4/66; H01M 50/566

(52) U.S. Cl. CPC B23K 26/22; B23K 26/0626; B23K 26/064; B23K 26/24; B23K 26/60; B23K 26/703; H01M 4/661; H01M 50/566; B23K 2101/38; B23K 2103/10; B23K 2103/166

(57) ABSTRACT

A method for welding a multi-layer aluminum foil of a current collector of a battery onto a corresponding structure includes performing a laser welding operation. The laser welding operation includes a spot welding operation of welding the multi-layer aluminum foil and the corresponding structure to each other using laser pulses. The corresponding structure is located under the multi-layer aluminum foil in a stacking direction of the multi-layer aluminum foil.

### CROSS-REFERENCE TO RELATED APPLICATIONS

This application is a continuation of International Application No. PCT/CN2023/119016 (WO 2024/056053 A1), filed on Sep. 15, 2023, and claims benefit to Chinese Patent Application No. CN 202211129537.9, filed on Sep. 16, 2022. The aforementioned applications are hereby incorporated by reference herein.

### FIELD

Embodiments of the present disclosure relate to the field of batteries, in particular to the field of lithium-ion batteries, and to a method for welding a multi-layer aluminum foil of a current collector of a battery onto a corresponding structure, a corresponding laser welding system, a corresponding control device for a laser welding system, and a corresponding computer program product.

### BACKGROUND

In recent years, with the development of battery technologies, people have increasingly strict requirements for batteries in terms of lightweight and high performance. Currently, lithium-ion batteries attract much attention, particularly owing to their excellent characteristics in many aspects compared with other types of batteries, and are increasingly used in various fields.

For lithium-ion batteries, multi-layer aluminum foils or multi-layer copper foils are typically used as current collectors. The current collector can collect currents generated by active materials coated on the aluminum foil or the copper foil to form a higher current. In this case, the current formed by the current collector is output via a terminal of the battery. For this end, an electrical connection needs to be formed between the current collector and the terminal. Specifically, in a lithium-ion battery, usually the multi-layer aluminum foil is used as the positive current collector, while the multi-layer copper foil is used as the negative current collector.

The purpose of using a multi-layer aluminum foil in this case is to obtain an increased surface area of the aluminum foil through more layers, so that more active substances can be coated on the surface of the aluminum foil.

As a result of the special structure of the terminal, it is impossible to perform ultrasonic welding on the multi-layer aluminum foil of the current collector and the terminal. In order to realize an effective electrical connection between the multi-layer aluminum foil and the terminal, now the commonly taken measure is to arrange a connection adapting sheet between the multi-layer aluminum foil and the terminal. Here, the multi-layer aluminum foil is connected to the connection adapting sheet by ultrasonic welding, while the connection adapting sheet is connected to the terminal by laser welding, thereby realizing an indirect connection between the multi-layer aluminum foil and the terminal. However, this not only produces adverse effects on the lightweight production of the battery, but also increases the current transfer resistance. In other words, it reduces the performance of the battery.

At present, a technical solution has been proposed to remove the connection adapting sheet and directly weld the multi-layer aluminum foil to the terminal by laser welding, during which welding process, however, cracks easily occur, particularly at the boundary of the fusion zone, and these cracks greatly reduce the overcurrent (overcharge) capability and the strength of weld seams, severely affecting the performance of the battery. And this is because the aluminum foil for the current collector has a thin thickness, so the aluminum foil near the heat-affected zone of the molten pool is easily deformed under high temperature, thus generating superimposed tensile stress during the deformation, and meanwhile molten aluminum has poor flow performance, resulting in a weakened tensile strength of the formed liquid film, so the film easily cracks under the action of tensile stress. In addition, the surface of the aluminum foil is normally covered with an Al₂O₃ oxide film which has a melting point and a hardness both much higher than that of a pure-aluminum base material, and consequently at least part of the oxide film cannot be completely melted during the welding process and will gather at the edge of the weld seam, leading to a significant increase in the hardness of the edge of the weld seam, where cracks are likely to occur. Uneven temperature and material deformation caused by laser energy input during the welding process will also increase the risk of cracking.

Particularly, the molten pool of a continuous, elongated weld seam has a very steep edge profile, leaving the aluminum foil at the edge of the molten pool severely deformed, and the resulting tensile stress easily causes continuous cracks at the fusion line of the molten pool. For another thing, the continuous, elongated weld seam has a longer length, so the input welding heat gradually accumulates along the feed direction of the laser beam, causing severer deformation at the tailing section of the weld seam, so the cracking of the rear section of the molten pool is even more obvious.

Therefore, continuous improvement is required.

### SUMMARY

Embodiments of the present invention provide a method for welding a multi-layer aluminum foil of a current collector of a battery onto a corresponding structure. The method includes performing a laser welding operation. The laser welding operation includes a spot welding operation of welding the multi-layer aluminum foil and the corresponding structure to each other using laser pulses. The corresponding structure is located under the multi-layer aluminum foil in a stacking direction of the multi-layer aluminum foil.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an example of a battery in a schematic partial sectional view.

FIG. 2 shows an exemplary embodiment of a laser welding system in a schematic perspective view.

FIG. 3 schematically shows a continuous, elongated weld seam on a multiple-layer aluminum foil.

FIG. 4 schematically shows a path of a laser beam during continuous laser welding in a top view of the multi-layer aluminum foil.

FIG. 5 schematically shows, in a top view similar to FIG. 3, a schematic diagram of a method for welding a multi-layer aluminum foil of a current collector of a battery onto a corresponding structure according to an exemplary embodiment of the disclosure.

FIG. 6 schematically shows a sectional view running through welding spot joints which is taken along a section line A-A in FIG. 5, according to some embodiments.

FIG. 7, FIG. 8 and FIG. 9 show layouts of welding spot joints and continuous welding seams in combination according to different exemplary embodiments of the disclosure.

### DETAILED DESCRIPTION

Embodiments of this disclosure provide an improved method for welding a multi-layer aluminum foil of a current collector of a battery onto a corresponding structure, a corresponding laser welding system, a corresponding control device for a laser welding system, and a corresponding computer program product.

According to a first aspect of the disclosure, provided is a method for welding a multi-layer aluminum foil of a current collector of a battery onto a corresponding structure, the method at least comprising: a laser welding operation, at least comprising: a spot welding operation of welding the multi-layer aluminum foil and the corresponding structure, which is located under the multi-layer aluminum foil in a stacking direction of the multi-layer aluminum foil, to each other by means of spot welding with laser pulses. This means that at least spot welding is used regardless of the connecting manner.

According to an alternative embodiment of the disclosure, the battery is a lithium-ion battery.

According to an alternative embodiment of the disclosure, the corresponding structure is a positive terminal of the battery.

According to an alternative embodiment of the disclosure, the corresponding structure is made of aluminum.

According to an alternative embodiment of the disclosure, the laser welding operation further comprises: a continuous welding operation of welding the multi-layer aluminum foil and the corresponding structure to each other by means of continuous laser welding. The continuous welding operation and the spot welding operation may be flexibly combined as needed.

According to an alternative embodiment of the disclosure, the spot welding operation and/or the continuous welding operation is performed by means of BrightLine Weld technology using a coaxial optical fiber, wherein the coaxial optical fiber comprises a core optical fiber and a ring-shaped optical fiber arranged around the core optical fiber so as to allow control of the laser welding operation by adjusting a density of energy transmitted by the core optical fiber and/or the ring-shaped optical fiber.

According to an alternative embodiment of the disclosure, the core optical fiber is used for increasing a depth of a molten pool, and the ring-shaped optical fiber uses a lower energy density relative to the core optical fiber to form a relatively shallow and wide welding area around an irradiation area of the core optical fiber.

According to an alternative embodiment of the disclosure, the spot welding operation comprises a pre-heating operation performed with the ring-shaped optical fiber and subsequent laser spot welding performed with the coaxial optical fiber.

According to an alternative embodiment of the disclosure, the spot welding operation comprises laser spot welding performed with the coaxial optical fiber and a subsequent slow cooling operation performed with the ring-shaped optical fiber.

According to a second aspect of the disclosure, provided is a battery, comprising: a multi-layer aluminum foil; and a corresponding structure located under the multi-layer aluminium foil in a stacking direction of the multi-layer aluminium foil; wherein the multi-layer aluminum foil is welded onto the corresponding structure by means of the method according to any one of the aforementioned embodiments.

According to a third aspect of the disclosure, provided is a laser welding system, comprising: a laser device for generating a laser beam; and a control device at least for controlling the laser device; wherein the laser welding system is configured to be adapted to perform the method according to any one of the aforementioned embodiments.

According to a fourth aspect of the disclosure, provided is a control device for a laser welding system, wherein the control device is configured to be adapted to perform the method according to any one of the aforementioned embodiments.

According to a fifth aspect of the disclosure, provided is a computer program product, comprising or storing computer program instructions which, when executed by a processor, implement the method according to any one of the aforementioned embodiments.

According to some exemplary embodiments of the disclosure, cracks, in particular continuous cracks, can be reduced, providing high tolerance to the ultrasonic pre-welding process of multi-layer aluminum foils and improving the welding strength, etc.

For a clearer understanding of the technical problems to be solved, technical solutions and advantageous technical effects of the present disclosure, the disclosure will be further described below in details in conjunction with the drawings and a number of exemplary embodiments. It is to be understood that specific embodiments described herein are merely for explaining the disclosure, rather than limiting the scope of protection of the disclosure.

Before starting the description, it should be noted first that in the description of the embodiments, orientations or positional relationships such as “upper” and “lower” are used with respect to the orientations or positional relationships shown in the drawings, and are used only for case of describing and simplifying the illustration, rather than indicating or implying that the device or element referred to must have a specific orientation or must be constructed and operated in a specific orientation, and therefore cannot be simply and indiscriminately construed as limitations on the disclosure, unless it is technically necessary.

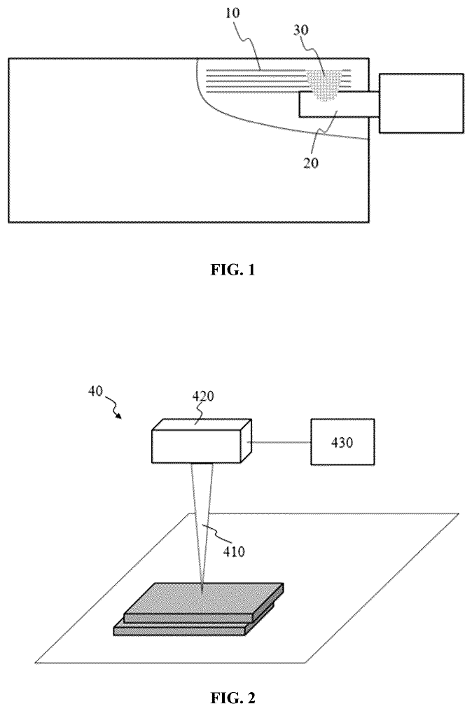

FIG. 1 shows an example of a battery in a schematic partial sectional view. The battery is exemplarily a lithium-ion battery here. However, those skilled in the art can understand that the technical idea of the present disclosure can also be applied to other types of batteries, such as sodium-ion batteries, rather than being limited to lithium-ion batteries. Furthermore, the technical idea of the present disclosure is not limited to square batteries, but it is also applicable to similar weld seam structures of pouch batteries, cylindrical batteries or batteries of other structures. A cell of the lithium-ion battery is formed, for example, by a multi-layer laminated structure consisting of aluminum foil-diaphragm-copper foil, with other substances required for the manufacture of the battery mingled therebetween. These are fully known to those skilled in the art and are not the focus of the present disclosure, so no more details will be elaborated here. These aluminum foil layers are typically made by rolling and are very thin. In a battery, the multi-layer aluminum foil protrudes for example from one end of the cell and may be pre-welded, by ultrasonic waves for example, to form a positive current collector. The positive current collector comprises a multi-layer aluminum foil 10 of any suitable number of layers, such as of 20 to 130 layers. The positive electrode of the battery further comprises, for example, a positive terminal and a positive tab, etc. The positive current collector generally needs to be connected to the positive terminal, and in some cases may also need to be connected to the positive tab or other components of the battery. Such connections are usually established by welding. Specifically, the multi-layer aluminum foil 10 is welded by a laser beam to the corresponding structure 20 (typically aluminum), such as the positive terminal, which is located under the multi-layer aluminum foil 10 in a stacking direction of the multi-layer aluminum foil 10, so that a weld seam 30 is formed.

FIG. 2 shows an exemplary embodiment of a laser welding system 40 in a schematic perspective view. The laser welding system 40 is used, for example, to weld the multi-layer aluminum foil 10 of the positive current collector of the battery shown in FIG. 1 to the corresponding structure 20. The laser welding system 40 for example comprises: a laser device 420 for generating a laser beam 410; and a control device 430 at least for controlling the laser device 420. The laser welding system 40 may further comprise a bearing platform (shown schematically as a plane in FIG. 2) for bearing objects to be welded (in this case, the multi-layer aluminum foil 10 and the corresponding structure 20) and/or a fixture for clamping the objects to be welded, etc. The bearing platform and/or the fixture may be fixed or be movable. The control device 430 may also control movements of the bearing platform and/or the fixture, if necessary. The laser device 420 may comprise, for example, a galvanometer scanner and may in particular comprise a PFO (Programming Focus Optical).

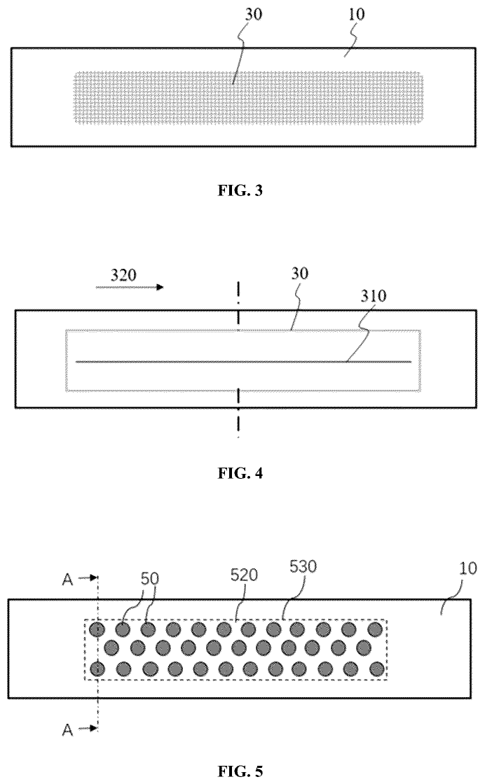

At present, when the multi-layer aluminum foil 10 of the current collector of the battery shown in FIG. 1 is welded to the corresponding structure 20, normally only the weld seam 30 as shown in FIG. 3 is used, where its length-to-width ratio is set so for the sake of clarity, and the actual width may be much smaller than the length. In order to form such a weld seam 30, the laser beam 410 is usually moved relative to the multi-layer aluminum foil 10 along a linear path 310 as shown in FIG. 4. Here, FIG. 3 and FIG. 4 are top views of the multi-layer aluminum foil 10 for example. The corresponding structure 20 that is located under the multi-layer aluminum foil 10 and may protrude beyond edges of the multi-layer aluminum foil 10 is omitted here for clarity. In FIG. 4, when the weld seam 30 is being formed, a feed direction 320 (i.e. a general moving direction of the laser head relative to the workpiece) is, for example, from left to right as indicated by the arrow. Since the width of the weld seam 30 transverse to the feed direction 320 is narrow, the cross section of the resulting molten pool is roughly U-shaped, as shown in FIG. 1, for example. The cross section of the molten pool here refers to the cross section of the weld seam 30 perpendicular to the feed direction 320, and the plane where the cross section is located is schematically shown by a dotted line in FIG. 4. As aluminum foils typically have a thickness between 8 and 13 microns, it can be known in combination with the description in the background art part that cracks are likely to appear at both ends of the weld scam 30 in the width direction.

FIG. 5 schematically shows, in a top view similar to FIG. 3, a schematic diagram of a method for welding a multi-layer aluminum foil 10 of a current collector of a battery onto a corresponding structure 20 according to an exemplary embodiment of the disclosure.

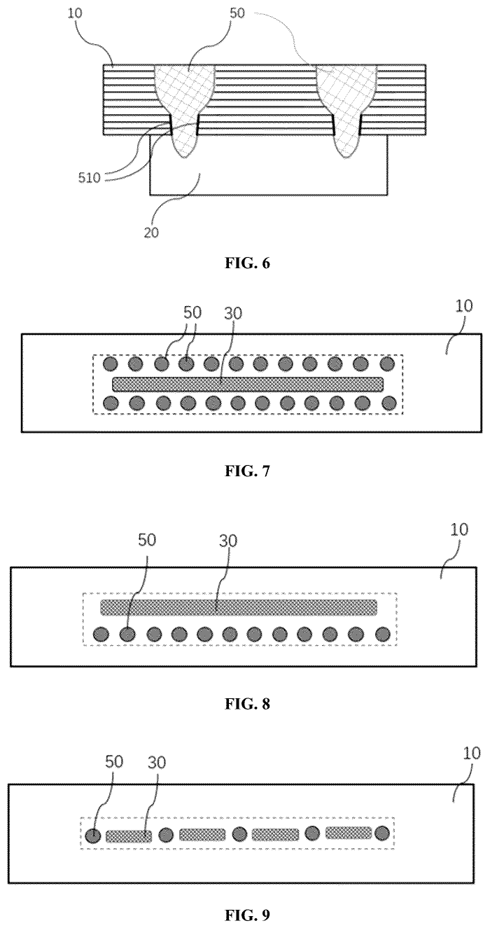

As shown in FIG. 5, the welding is performed in a manner of laser spot welding, where laser pulses are used for welding to form welding spot joints 50, through which welding spot joints the multi-layer aluminum foil 10 of the current collector of the battery is connected to the corresponding structure 20. FIG. 6 schematically shows a sectional view running through welding spot joints 50 which is cut along a section line A-A in FIG. 5.

As shown in FIG. 6, it is found in practice that cracks 510 only occur at a certain depth of each welding spot joint 50 around the outer circumference of the welding spot joint 50. Accordingly, no continuous cracks will be formed in the direction of stress of a peel test, thereby increasing the peel strength.

Those skilled in the art may also understand that, compared with the weld seam 30 which is only in a continuous, elongated form as shown in FIG. 3 and FIG. 4, the use of spot welding can increase the stress area per unit welding area, thereby further improving the peel strength. Moreover, in the case of the weld seam 30 only in a continuous, elongated form as shown in FIG. 3 and FIG. 4, once a crack occurs at the outer circumferential edge of the weld seam, all those aluminum foil layers will become easily peeled off, and the entire tearing-off process is quick and difficult to terminate. However, in the case of spot welding, the welding strength of each welding spot joint is independent, which can effectively improve the welding strength.

Furthermore, the spot welding method has a high tolerance to the ultrasonic pre-welding process of the multi-layer aluminum foil 10. In other words, even if a large gap appears during the ultrasonic pre-welding process, there will be no significant influence on the welding strength of the subsequent welding.

In addition, compared with continuous laser welding, welding using laser pulses can also significantly reduce the overall heat input, thereby reducing deformation of the aluminum foil under high temperature, and further reducing generation of cracks, in particular continuous cracks.

The advantages of the use of spot welding in the present disclosure has been outlined above, but those skilled in the art may understand that the actual advantages may not be limited thereto. In any case, the spot welding method of the present disclosure fully take into consideration the characteristics of the multi-layer aluminum foil 10 and the characteristics of laser welding and match the two well with each other, and no one has ever realized this before.

As shown in FIG. 5, several rows of welding spot joints 50 are shown, with each of the welding spot joints 50 separated from one another without any contact. Specifically, three horizontal rows of welding spot joints 50 are shown in FIG. 5, and these welding spot joints 50 are roughly in even distribution in a welding area 520. The welding area 520 is schematically shown with a dashed block 530 in FIG. 5. “Welding area” can be understood as an area which is delimited by the outermost edge of each welding site, such as each welding spot joint 50.

Similarly, FIG. 5 only schematically shows one example of a layout of welding spot joints 50, and in practice the layout of welding spot joints 50 can be designed according to the specific conditions, such as the welding area. For example, if it is found in practice that the current flowing area is insufficient, it is possible to increase the number of welding spot joints in a determined welding area, namely, the density, to meet the requirements.

Furthermore, those skilled in the art may understand that although the welding area in FIG. 5 is welded through welding spot joints 50 only, practical situations are not limited thereto. For example, it is also possible to weld the multi-layer aluminum foil 10 to the corresponding structure 20 using a combination of continuous laser welding (i.e. the continuous laser weld seam shown in FIG. 3 and FIG. 4) and laser pulse spot welding (FIG. 5). Particularly, if it is found that the current flowing area is still not enough after the increase of welding spot joints 50, a supplementary continuous laser welding operation may be performed to meet the requirements.

Those skilled in the art may understand that even if spot welding is used in only one site in the welding area while other sites are still welded by continuous welding or other types of welding (or other possible connections), the existing problems in the prior art can also be alleviated. Therefore, the present disclosure does not limit the number of welding spot joints.

FIG. 7, FIG. 8 and FIG. 9 show layouts of the welding spot joints 50 and continuous welding seam 30 in combination according to different exemplary embodiments of the disclosure, but practical situations are not limited thereto.

The technology of BrightLine Welding of the present applicant may be used for welding, particularly for spot welding. This technology is under the protection of the related patents of the applicant. BrightLine Welding adopts “2-in-1” optical fibers, where a laser source guides lasers simultaneously into a core optical fiber and a ring-shaped optical fiber arranged around the core optical fiber, and two laser beams act together in the processing area, so that energy density can be adjusted within the cross section of the laser beams, for example, it is possible to adjust the energy density of the core and the outer ring (e.g. circular ring) within the cross section of the laser beams.

According to an exemplary embodiment of the disclosure, with the BrightLine Welding technology, the core optical fiber may be responsible for increasing a depth of a molten pool, while the ring-shaped optical fiber uses a relatively low energy density to additionally form a shallow and wide welding area around an irradiation area of the core optical fiber, thereby achieving equally pre-heating and slow cooling to further reduce the cracks caused by shrinking of the aluminum foil after welding.

According to an exemplary embodiment of the disclosure, with the BrightLine Welding technology, the ring-shaped optical fiber may be used first for a pre-welding once which is followed by the formal welding operation, meaning that at least the core optical fiber is used for the welding. The use of the ring-shaped optical fiber for pre-heating before the welding can reduce cracks.

According to an exemplary embodiment of the disclosure, with the BrightLine Welding technology, it is also possible to weld again using the ring-shaped optical fiber after the formal welding, thereby enabling a slow cooling process after the welding which can reduce cracks.

In addition, the method of the present disclosure may be performed with the control device 430 of FIG. 2, for example, and the control device 430 may contain or store, for example, a corresponding computer program product comprising computer program instructions which, when executed by a processor, control the laser welding system 40 of FIG. 2 to implement the method described above. The computer program product may be a computer-readable program carrier.

While specific embodiments of the disclosure have been described in detail here, they have been presented for the purpose of explanation only and should not be construed as limitations on the scope of the disclosure. Various substitutions, changes and modifications can be devised without deviating from the spirit and scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for welding a multi-layer aluminum foil of a current collector of a battery onto a corresponding structure, the method comprising:
performing a laser welding operation, the laser welding operation comprising a spot welding operation of welding the multi-layer aluminum foil and the corresponding structure to each other using laser pulses, wherein the corresponding structure is located under the multi-layer aluminum foil in a stacking direction of the multi-layer aluminum foil.

2. The method according to claim 1, wherein
the battery is a lithium-ion battery; and/or
the corresponding structure is a positive terminal of the battery; and/or
the corresponding structure is made of aluminum.

3. The method according to claim 1, wherein
the laser welding operation further comprises a continuous welding operation of welding the multi-layer aluminum foil and the corresponding structure to each other by a continuous laser welding.

4. The method according to claim 2, wherein
the laser welding operation further comprises a continuous welding operation of welding the multi-layer aluminum foil and the corresponding structure to each other by a continuous laser welding.

5. The method according to claim 1, wherein
the spot welding operation is performed by using BrightLine Weld technology using a coaxial optical fiber, wherein the coaxial optical fiber comprises a core optical fiber and a ring-shaped optical fiber arranged around the core optical fiber so as to allow control of the laser welding operation by adjusting a density of energy transmitted by the core optical fiber and/or the ring-shaped optical fiber.

6. The method according to claim 2, wherein
the spot welding operation is performed by using BrightLine Weld technology using a coaxial optical fiber, wherein the coaxial optical fiber comprises a core optical fiber and a ring-shaped optical fiber arranged around the core optical fiber so as to allow control of the laser welding operation by adjusting a density of energy transmitted by the core optical fiber and/or the ring-shaped optical fiber.

7. The method according to claim 3, wherein
the spot welding operation and/or the continuous welding operation is performed by using BrightLine Weld technology using a coaxial optical fiber, wherein the coaxial optical fiber comprises a core optical fiber and a ring-shaped optical fiber arranged around the core optical fiber so as to allow control of the laser welding operation by adjusting a density of energy transmitted by the core optical fiber and/or the ring-shaped optical fiber.

8. The method according to claim 4, wherein
the spot welding operation and/or the continuous welding operation is performed by using BrightLine Weld technology using a coaxial optical fiber, wherein the coaxial optical fiber comprises a core optical fiber and a ring-shaped optical fiber arranged around the core optical fiber so as to allow control of the laser welding operation by adjusting a density of energy transmitted by the core optical fiber and/or the ring-shaped optical fiber.

9. The method according to claim 5, wherein
the core optical fiber is used for increasing a depth of a molten pool, and the ring-shaped optical fiber uses a lower energy density relative to the core optical fiber to form a relatively shallow and wide welding area around an irradiation area of the core optical fiber.

10. The method according to claim 6, wherein
the core optical fiber is used for increasing a depth of a molten pool, and the ring-shaped optical fiber uses a lower energy density relative to the core optical fiber to form a relatively shallow and wide welding area around an irradiation area of the core optical fiber.

11. The method according to claim 7, wherein
the core optical fiber is used for increasing a depth of a molten pool, and the ring-shaped optical fiber uses a lower energy density relative to the core optical fiber to form a relatively shallow and wide welding area around an irradiation area of the core optical fiber.

12. The method according to claim 8, wherein
the core optical fiber is used for increasing a depth of a molten pool, and the ring-shaped optical fiber uses a lower energy density relative to the core optical fiber to form a relatively shallow and wide welding area around an irradiation area of the core optical fiber.

13. The method according to claim 5, wherein
the spot welding operation comprises a pre-heating operation performed with the ring-shaped optical fiber and a subsequent laser spot welding performed with the coaxial optical fiber.

14. The method according to claim 6, wherein
the spot welding operation comprises a pre-heating operation performed with the ring-shaped optical fiber and a subsequent laser spot welding performed with the coaxial optical fiber.

15. The method according to claim 7, wherein
the spot welding operation comprises a pre-heating operation performed with the ring-shaped optical fiber and a subsequent laser spot welding performed with the coaxial optical fiber.

16. The method according to claim 5, wherein
the spot welding operation comprises a laser spot welding performed with the coaxial optical fiber and a subsequent slow cooling operation performed with the ring-shaped optical fiber.

17. The method according to claim 6, wherein
the spot welding operation comprises s laser spot welding performed with the coaxial optical fiber and a subsequent slow cooling operation performed with the ring-shaped optical fiber.

18. The method according to claim 7, wherein
the spot welding operation comprises a laser spot welding performed with the coaxial optical fiber and a subsequent slow cooling operation performed with the ring-shaped optical fiber.

19. A battery, comprising:
a multi-layer aluminum foil; and
a corresponding structure located under the multi-layer aluminium foil in a stacking direction of the multi-layer aluminium foil;
wherein the multi-layer aluminum foil is welded onto the corresponding structure by the method according to claim 1.

20. A laser welding system, comprising:
a laser device for generating a laser beam; and
a control device for controlling the laser device;
wherein the laser welding system is configured to be adapted to perform the method according to claim 1.
